(19) United States
(12) Patent Application Publication
(10) Pub. No.: US 2019/0138719 A1
(43) Pub. Date: May 9, 2019

(54) METHODS AND APPARATUS FOR DETECTING A SIDE CHANNEL ATTACK USING A CACHE STATE

(71) Applicants: Salmin Sultana, Hillsboro, OR (US); Li Chen, Hillsboro, OR (US); Abhishek Basak, Hillsboro, OR (US); Jason Martin, Beaverton, OR (US); Justin Gottschlich, Santa Clara, CA (US)

(72) Inventors: Salmin Sultana, Hillsboro, OR (US); Li Chen, Hillsboro, OR (US); Abhishek Basak, Hillsboro, OR (US); Jason Martin, Beaverton, OR (US); Justin Gottschlich, Santa Clara, CA (US)

(21) Appl. No.: 16/234,140

(22) Filed: Dec. 27, 2018

(51) Int. Cl. G06F 21/55; G06N 20/00

(52) U.S. Cl. CPC G06F 21/554; G06F 21/53; G06N 20/00

(57) ABSTRACT

Methods, apparatus, systems and articles of manufacture for detecting a side channel attack are disclosed. An example apparatus includes a histogram generator to generate a histogram representing cache access activities. A histogram analyzer is to determine at least one statistic based on the histogram. A machine learning model processor is to apply a machine learning model to the at least one statistic to attempt to identify a side channel attack. A multiple hypothesis tester to perform multiple hypothesis testing to determine a probability of the cache access activities being benign. An anomaly detection orchestrator is to, in response to the machine learning model processor identifying that the at least one statistic is indicative of the side channel attack and the probability not satisfying a similarity threshold, cause the performance of a responsive action to mitigate the side channel attack.

### FIELD OF THE DISCLOSURE

This disclosure relates generally to anomaly detection, and, more particularly, to methods and apparatus for detecting a side channel attack using a cache state.

### BACKGROUND

Over the past few years, micro-architectural side channel attacks have evolved from theoretical attacks on cryptographic algorithm implementations to highly practical generic attack primitives. For example, vulnerabilities such as the Meltdown and Spectre attacks exploit vulnerabilities in modern processors and break memory isolation among processes and/or privilege layers to gain access to data from other applications and/or the operating system (OS). Such data may include passwords, personal photos, emails, instant messages, and even business-critical documents. Side channel attacks exploit the fact that hardware resources are physically shared among processes running in different isolation domains.

### BRIEF DESCRIPTION OF THE DRAWINGS

FIG. 1 is a block diagram of an example system constructed in accordance with teachings of this disclosure for detecting a side channel attack using a cache state.

FIG. 2 is a diagram representing an example histogram of cache accesses.

FIG. 3 is a flowchart representative of example machine readable instructions which may be executed to implement the example side channel anomaly detector of FIG. 1.

FIG. 4 is a flowchart representative of example machine readable instructions which may be executed to implement the example side channel anomaly detector of FIG. 1 to train a machine learning model and anomaly detection thresholds.

FIG. 5 is a flowchart representative of example machine readable instructions which may be executed to implement the example side channel anomaly detector of FIG. 1 to sample cache state information.

FIG. 6 is a diagram representing an example cache heat map (CHM) that may be used in place of the example histogram of FIG. 2.

FIG. 7 is a block diagram of an example processing platform structured to execute the instructions of FIGS. 3, 4, and/or 5 to implement the example side channel anomaly detector of FIG. 1.

The figures are not to scale. In general, the same reference numbers will be used throughout the drawing(s) and accompanying written description to refer to the same or like parts.

### DETAILED DESCRIPTION

Side channel attacks exploit the fact that hardware resources of a computing system, such as cache, branch predictor, branch target buffer, execution units, etc., are physically shared among processes running on the computing system. Mitigations against side channel attacks mainly focused on patching and proposing new architecture designs. However, not all systems can be patched. Even where possible, patching can be difficult. Moreover, patching sometimes introduces a large amount of operational overhead including, for example, physically replacing hardware components. Example approaches disclosed herein seek to mitigate side channel attacks by early detection of such attacks, enabling responsive actions to be taken to avoid the impact(s) of a side channel attack.

Cache Side Channel Attacks (SCA) are serious threats to information security where multiple processes/virtual machines (VMs) execute on the same physical machine (e.g., share hardware resources of the physical machine). The cache of the central processing unit (CPU) is one of the most dangerous shared resources since the CPU cache is shared by all of the cores in a CPU package. As a result, the CPU cache represents a possible attack vector to perform fine-grained, high-bandwidth, low-noise cross-core attacks.

A cache SCA typically includes three phases: a priming phase, a triggering phase, and an observing phase. In the priming phase, an attacker places the system into a desired initial state (e.g., flushes cache lines). In the triggering phase, a victim performs some action that conveys information through a side channel. In the observing phase, the attacker detects the presence of the information conveyed through the side channel. Such information may include sensitive information such as, for example, passwords, personal photos, emails, instant messages, business-critical information, social security numbers, etc.

To leak sensitive information, the cache SCAs utilize one or more techniques such as Flush+Reload, Evict+Reload, Prime+Probe, Flush+Flush, etc. In Flush+Reload and Evict+Reload techniques, the attacker begins by evicting a cache line shared with the victim from the cache. After the victim (e.g., a personal computer, a phone, a processor platform, an on-board vehicle processor, etc.) executes for a while, the attacker measures the time it takes to perform a memory read at the address corresponding to the evicted cache line. If the victim accessed the monitored cache line, the data will be in the cache and the access will be fast. By measuring the access time, the attacker learns whether the victim accessed the monitored cache line between the eviction and probing operations.

In Prime+Probe attacks, the attacker fills the targeted cache set(s) by accessing an eviction set (a sequence of memory addresses mapped into same cache set) and waits a time interval. As the victim process operates, the victim process may evict cache lines. In the observing phase, the attacker measures the cache access time to prime the targeted cache set(s) and identify the evicted cache lines to extract data access pattern of the victim application.

In Flush+Flush attacks, the attacker measures differences in the duration(s) of flushing a cache line. In this attack, the attacker flushes all the cache lines and lets the victim process run normally. The attacker then again flushes all the cache lines and measures the execution time of the flushing instruction. If the victim process has accessed to a specific memory location, the data will be cached and the flushing instruction will take a longer time.

In the priming and observing phases of cache SCAs, the attacker repeatedly accesses the targeted cache set(s) or cache set(s) containing the targeted cache lines at a high frequency. Note that the anomalous cache behavior only occurs in the priming and observing phases of the attack, while the triggering phase resembles normal program behavior. Example approaches disclosed herein can be used to detect such access patterns and, in response to such detection, perform a responsive action to mitigate the effects of the SCA.

In example approaches disclosed herein, a machine learning (ML) analysis of cache access patterns in a system is performed to detect ongoing cache SCAs (speculative or traditional) in an early phase (e.g., during the priming phase, and/or during the triggering phase). In example approaches disclosed herein, a machine learning model is trained using a histogram of cache set states to characterize cache access behaviors corresponding to a priming phase, a triggering phase, an observing phase, or as a non-attack. During operation, cache set states are sampled, and a histogram is created. The histogram and/or values derived from the histogram are used as an input to the machine learning model to classify the cache state and detect an ongoing attack (e.g., determine if the cache state samples belong to any phase of a cache SCA).

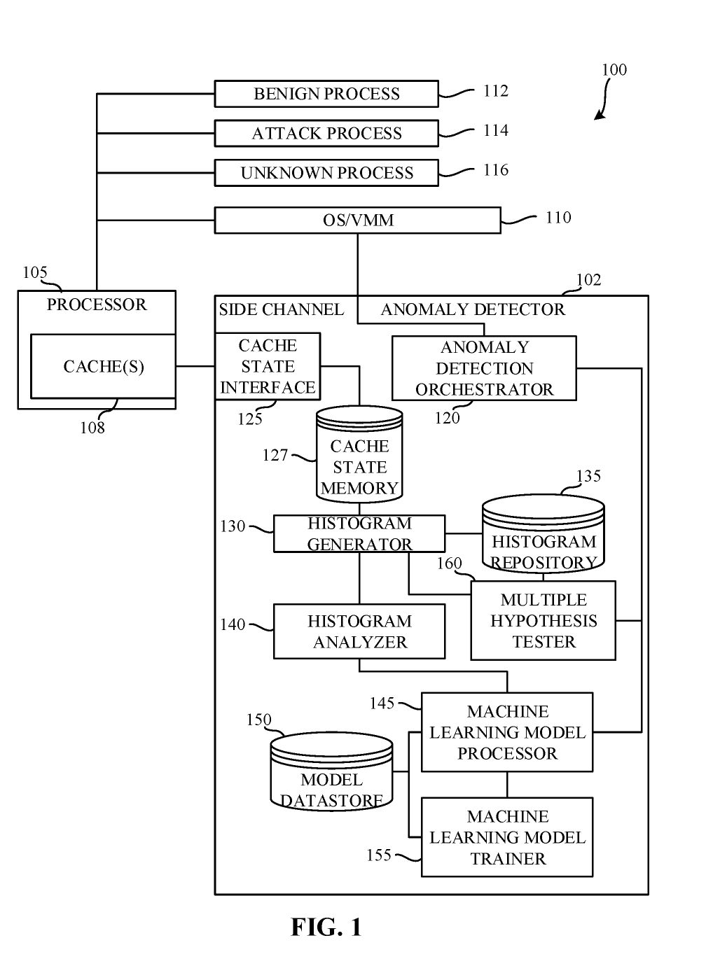

FIG. 1 is a block diagram of an example system 100 constructed in accordance with teachings of this disclosure for detecting a side channel attack. In examples disclosed herein, a machine-learning based detection system is used to detect speculative and traditional cache side channel attacks using cache access patterns in a computing system. Example approaches disclosed herein make use of a spatial distribution of the accessed cache lines (e.g., accessed cache lines cluster) to identify various stages of a cache side channel attack based on the cache access activity in those cache lines. The example system 100 of FIG. 1 includes a side channel anomaly detector 102, a processor 105, and an operating system/virtual machine manager 110. The example processor 105 includes one or more cache(s) 108 that are utilized by processes executing on the processor 105. The example system 100 of the illustrated example of FIG. 1 shows a benign process 112, an attack process 114 and an unknown process 116. Any one or more of such processes 112, 114, 116 may be executed at the direction of the OS/VMM 110.

The example processor 105 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), application specific integrated circuit(s) (ASIC(s)), programmable logic device(s) (PLD(s)), field programmable logic device(s) (FPLD(s)), digital signal processor(s) (DSP(s)), etc. The example processor includes the one or more cache(s) 108. The example cache(s) 108 of the illustrated example of FIG. 1 includes a level 1 Data (L1-D) cache and a level 1 instruction (L1-I) cache. However, in some examples, other caches may be used such as, for example, a last-level cache (LLC). Some example micro-architecture(s) have an L1-I cache of 64 8-way associative cache sets (e.g., 64 Bytes per cache line), L1-D cache of 64 8-way set associative cache sets, and LLC of 2048 sets (up to 16-way set associative). The LLC is inclusive of all cache levels above the LLC. That is, data contained in the core caches also logically resides in the LLC. Each cache line in the LLC holds an indication of the cores that may have this line in their L2 and L1 caches. In some examples, multiple caches may be included corresponding to, for example, each core of a CPU, each CPU in the computing system, etc.

The example OSS/VMM 110 of the illustrated example of FIG. 1 represents at least one of the operating system and/or virtual machine manager of the computing system 100. In examples disclosed herein, the OS/VMM 110 manages execution of processes by the processor 105. In some examples, the OS/VMM 110 controls isolation of the processes executed by the processor by, for example, instructing the processor to physically separate the process domains of various processes. For example, the processor 105 may, at the direction of the OS/VMM 110, physically separate (e.g., on two separate cores, on two separate CPUs, etc.) the execution space and/or memory accessible to various processes. Such separation reduces (e.g., minimizes) the shared hardware resources between the two domains (process, VM, etc.) and thereby reduces (e.g., minimizes) a risk that sensitive data may be exposed.

The example benign process 112 of the illustrated example of FIG. 1 is a process that stores sensitive information (e.g., passwords, images, documents, etc.) in the cache(s) 108. The example attack process 114 of the illustrated example of FIG. 1 is a process that seeks to perform a side channel attack to gain access to sensitive information stored by the benign process 112. In some examples, the example attack process 114 is not a malicious process, in that the attack process 114 does not actually share the sensitive information outside of the computing system. An attack pattern may be simulated by such a non-malicious attack process without actually exposing any sensitive user information (e.g., passwords, images, documents, etc.). However, in some examples, the example attack process 114 is a malicious process and may attempt to share the sensitive information outside of the computing system 100. In such examples, additional safeguards may be put in place to prevent the actual sharing of sensitive information such as, for example, a firewall that prevents communications including the sensitive information from reaching their destination.

The example unknown process 116 of the illustrated example of FIG. 1 represents a process that is not known to be a benign process or an attack process. As a result, the side channel anomaly detector 102 monitors cache access patterns (e.g., cache access patterns associated with the unknown process 116), and processes such cache access patterns to attempt to determine whether the unknown process 116 is performing an attack.

The example side channel anomaly detector 102 of the illustrated example of FIG. 1 includes an anomaly detection orchestrator 120, a cache state interface 125, a cache state memory 127, a histogram generator 130, a histogram repository 135, a histogram analyzer 140, a machine learning model processor 145, a model data store 150, a machine learning model trainer 155, and a multiple hypothesis tester 160.

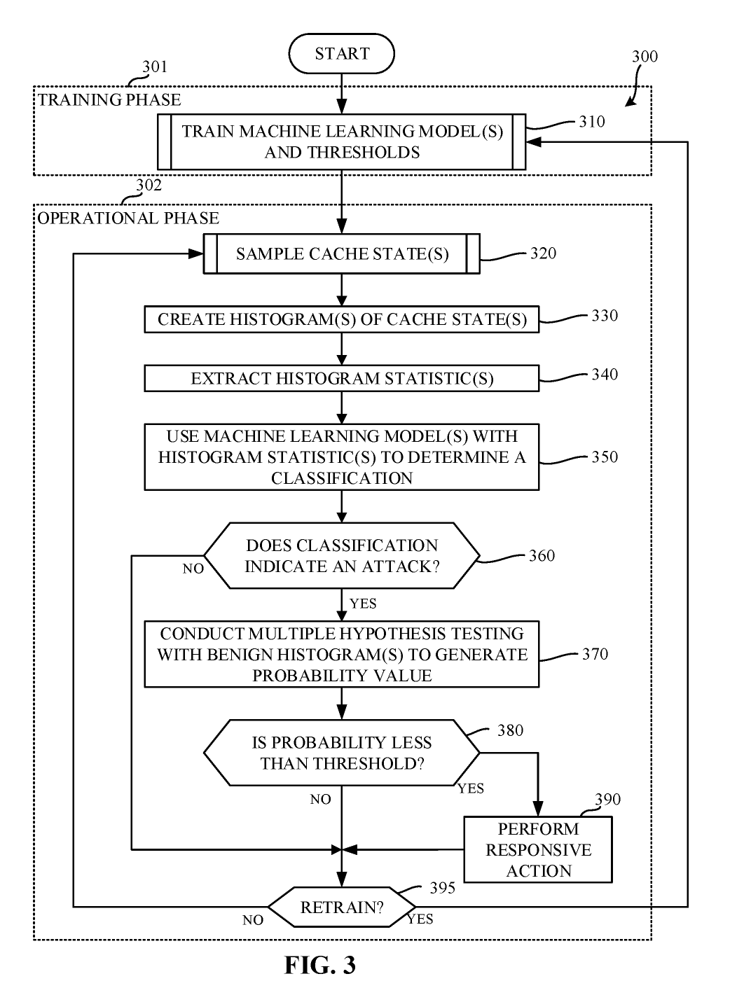

The example anomaly detection orchestrator 120 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. In this example, the anomaly detection orchestrator 120 implements means for mitigating a side channel attack. The means for mitigating may additionally or alternatively be implemented by blocks 360, 380, 390, and/or 395 of FIG. 3. The example anomaly detection orchestrator 120 controls operation of the side channel anomaly detector 102 and interfaces with the OS/VMM 110 to identify the potential occurrence of an anomalous behavior (e.g., a side channel attack). In some examples, to facilitate training, the example anomaly detector 102 interfaces with the OS/VMM 110 to instruct the OS/VMM to execute one or more of the benign process 112 and/or the attack process 114.

The example cache state interface 125 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. The cache state interface 125 retrieves cache state information from the cache 108. The example cache state interface 125 stores the cache state information in the cache state memory 127. In examples disclosed herein, retrieval of cache state information is performed at periodic monitoring intervals for a threshold amount of time (e.g., once per minute for ten minutes).

The example cache state memory 127 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example cache state memory 127 may be in any data format such as, for example, binary data, comma delimited data, tab delimited data, structured query language (SQL) structures, etc. While, in the illustrated example, the cache state memory 127 is illustrated as a single device, the example cache state memory 127 and/or any other data storage devices described herein may be implemented by any number and/or type(s) of memories. In the illustrated example of FIG. 1, the example cache state memory 127 stores cache state information collected by the cache state interface 125.

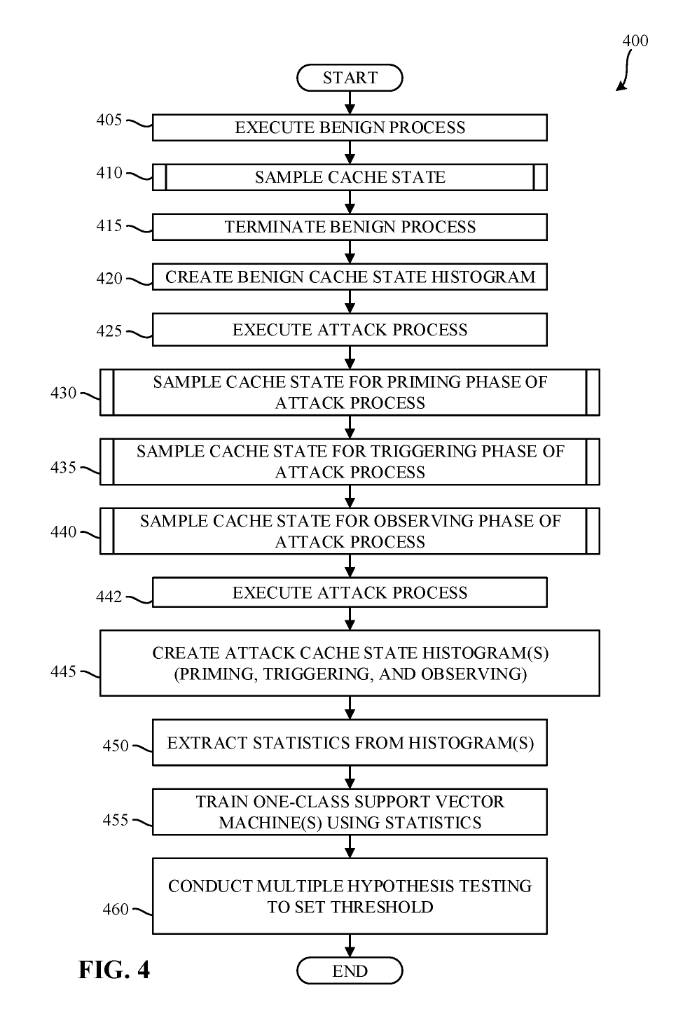

The example histogram generator 130 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. In this example, the histogram generator 130 implements means for generating a histogram. The means for generating may additionally or alternatively be implemented by blocks 425 and/or 445 of FIG. 4. The example histogram generator 130 generates a histogram of the sampled cache state(s) (e.g., the sampled cache states stored in the example cache state memory 127). In examples disclosed herein, the histogram generator 130 creates a separate histogram for each sampled cache state. That is, a first histogram is created corresponding to the L1-D cache (e.g., an L1-D histogram), and a second histogram is created corresponding to the L1-I cache (e.g., an L1-I histogram). However, any number of histograms corresponding to any number of caches may additionally or alternatively be created.

The example histogram repository 135 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example histogram repository 135 may be in any data format such as, for example, binary data, comma delimited data, tab delimited data, structured query language (SQL) structures, etc. While, in the illustrated example, the histogram repository 135 is illustrated as a single device, the example histogram repository 135 and/or any other data storage devices described herein may be implemented by any number and/or type(s) of memories. In the illustrated example of FIG. 1, the example histogram repository 135 stores histograms generated by the histogram generator 130. In some examples, the histogram repository 135 may store histograms created by histogram generator(s) of another side channel anomaly detector 102. That is, histograms may be generated by one computing system and supplied to another computing system to facilitate operation thereof. In examples disclosed herein, histograms in the histogram repository 135 are labeled according to whether the histogram represents benign activity, attack activity, and/or other type(s) of activities.

The example histogram analyzer 140 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. In this example, the histogram analyzer 140 implements means for determining a statistic. The means for determining may additionally or alternatively be implemented by blocks 340 and/or 450 of FIGS. 3 and/or 4. The example histogram analyzer 140 extracts a histogram statistic(s) from the histogram(s). In examples disclosed herein, the statistic includes at least one of a minimum value, a maximum value, a percentile value, a standard deviation value, a skewness value, one or more values representing a range in the histogram, an upper-hinge value of the histogram, etc. In examples disclosed herein, separate statistics are created for each of the histogram(s). That is, a first statistic (and/or first set of statistics) is created for the L1-D histogram, and a second statistic (and/or second set of statistics) is created for the L1-I histogram.

The example machine learning model trainer 155 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. In this example, the machine learning model trainer 155 implements means for training a machine learning model. The means for training may additionally or alternatively be implemented by block 455 of FIG. 4. During training, a machine learning model is stored in the machine learning model datastore 150 by the example machine learning model trainer 155. This machine learning model may later be utilized by the example machine learning model processor 145 to detect an anomaly and/or attack. In examples disclosed herein, training is performed using Stochastic Gradient Descent. However, any other approach to training a machine learning model may additionally or alternatively be used.

The example model data store 150 of the illustrated example of FIG. 1 is implemented by any memory, storage device and/or storage disc for storing data such as, for example, flash memory, magnetic media, optical media, solid state memory, hard drive(s), thumb drive(s), etc. Furthermore, the data stored in the example model data store 150 may be in any data format such as, for example, binary data, comma delimited data, tab delimited data, structured query language (SQL) structures, etc. While, in the illustrated example, the model data store 150 is illustrated as a single device, the example model data store 150 and/or any other data storage devices described herein may be implemented by any number and/or type(s) of memories. In the illustrated example of FIG. 1, the example model data store 150 stores machine learning models trained by the machine learning model trainer 155. In some examples, the model(s) stored in the example model data store 150 may be retrieved from another computing system (e.g., a server that provides the model(s) to the side channel anomaly detector 102).

The example machine learning model processor 145 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. In this example, the machine learning model processor 145 implements means for applying a machine learning model. The means for applying may additionally or alternatively be implemented by block 350 of FIG. 3. During training, a machine learning model is stored in the machine learning model datastore 150 by the example machine learning model trainer 155. This machine learning model may later be utilized by the example machine learning model processor 145 to detect an anomaly and/or attack. That is, the example machine learning model processor 145 implements a machine learning model (e.g., a neural network) according to the model information stored in the model datastore 150. In examples disclosed herein, the example machine learning model implements one or more support vector machine(s). However, any other past, present, and/or future machine learning topology(ies) and/or architecture(s) may additionally or alternatively be used such as, for example, deep neural network (DNN), a convolutional neural network (CNN), a feed-forward neural network.

The example multiple hypothesis tester 160 of the illustrated example of FIG. 1 is implemented by a logic circuit such as, for example, a hardware processor. However, any other type of circuitry may additionally or alternatively be used such as, for example, one or more analog or digital circuit(s), logic circuits, programmable processor(s), ASIC(s), PLD(s), FPLD(s), programmable controller(s), GPU(s), DSP(s), etc. In this example, the multiple hypothesis tester 160 implements means for testing using multiple hypothesis testing. The means for testing may additionally or alternatively be implemented by blocks 370 and/or 460 of FIGS. 3 and/or 4. The example multiple hypothesis tester 160 conducts multiple hypothesis testing to compare histogram(s) to each other. For example, the multiple hypothesis tester 160 may perform multiple hypothesis testing to compare a histogram corresponding to an unknown process to one or more characteristic benign histograms stored in the histogram repository 135 to generate a p-value indicative of whether the unknown process is similar to a benign process. In examples disclosed herein, the multiple hypothesis testing performed by the multiple hypothesis tester 160 is implemented using a Kolmogorov-Smirnov test. However, other types of multiple hypothesis testing algorithms may additionally or alternatively be used.

The example p-value produced by the multiple hypothesis testing represents a similarity of the generated histogram(s) to the one or more characteristic benign histograms. In examples disclosed herein, p-values are created on a scale of zero to one. However, any other scale or nomenclature for representing a similarity may additionally or alternatively be used. A high p-value (e.g., a p-value near or approaching one, a p-value greater than or equal to 0.8) represents a high similarity to a benign histogram (i.e., that the generated histograms represent benign activity), whereas a low p-value (e.g., a p-value near approaching zero, a p-value less than or equal to 0.2) represents a low similarity to the benign histogram (i.e., that the generated histograms do not represent benign activity).

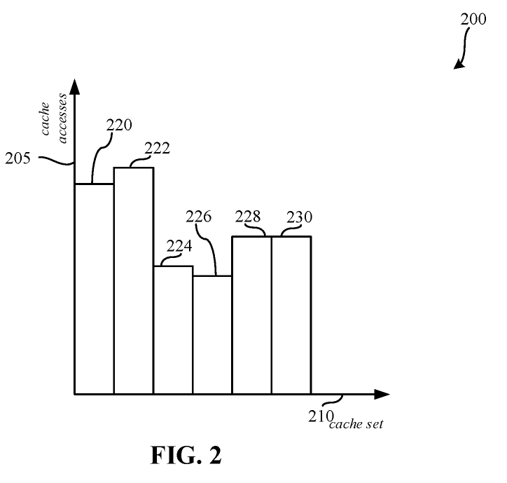

FIG. 2 is a diagram representing an example histogram 200 of cache accesses generated by the example histogram generator 130 of FIG. 1. The example diagram includes a vertical axis 205 representing a number of cache accesses, and a horizontal axis 210 representing cache sets. In the illustrated example of FIG. 2, cache accesses for various cache sets (e.g., L1-D, L1-I, LLC, etc.) are represented along the horizontal axis 210 in distinct bins. In the illustrated example of FIG. 2, six bins 220, 222, 224, 226, 228, 230 correspond to six cache sets, and/or portions of the cache sets. That is, a first bin 220 may correspond to a first portion of a first cache, a second bin 222 may correspond to a second portion of the first cache, a third bin 224 may correspond to a third portion of the first cache, etc. To extract features for machine learning analysis, the example histogram summarizes access patterns (e.g., a total number of accesses that have been performed for each of the cache sets) within a time interval (e.g., since a prior measurement/histogram was generated). In the illustrated example of FIG. 2, a single histogram is shown. However, in practice, multiple different histograms corresponding to different caches and/or cache types may additionally or alternatively be created. In some examples, different caches may be represented in a single histogram. Note that the summary histogram loses some timing information about the individual accesses to a cache. That is, an individual cache access is represented as a single item (e.g., a count) within one of the bins of the histogram. However, for cache SCA attacks, the features that lend themselves to attack detection are the frequency of accesses to cache set(s) within an interval, rather than the cache access sequence itself.

While an example manner of implementing the side channel anomaly detector 102 is illustrated in FIG. 1, one or more of the elements, processes and/or devices illustrated in FIG. 1 may be combined, divided, re-arranged, omitted, eliminated and/or implemented in any other way. Further, the example anomaly detection orchestrator 120, the example cache state interface 125, the example histogram generator 130, the example histogram analyzer 140, the example machine learning model processor 145, the example machine learning model trainer 155, the example multiple hypothesis tester 160, and/or, more generally, the example side channel anomaly detector 102 of FIG. 1 may be implemented by hardware, software, firmware and/or any combination of hardware, software and/or firmware. Thus, for example, any of the example anomaly detection orchestrator 120, the example cache state interface 125, the example histogram generator 130, the example histogram analyzer 140, the example machine learning model processor 145, the example machine learning model trainer 155, the example multiple hypothesis tester 160, and/or, more generally, the example side channel anomaly detector 102 of FIG. 1 could be implemented by one or more analog or digital circuit(s), logic circuits, programmable processor(s), programmable controller(s), graphics processing unit(s) (GPU(s)), digital signal processor(s) (DSP(s)), application specific integrated circuit(s) (ASIC(s)), programmable logic device(s) (PLD(s)) and/or field programmable logic device(s) (FPLD(s)). When reading any of the apparatus or system claims of this patent to cover a purely software and/or firmware implementation, at least one of the example anomaly detection orchestrator 120, the example cache state interface 125, the example histogram generator 130, the example histogram analyzer 140, the example machine learning model processor 145, the example machine learning model trainer 155, the example multiple hypothesis tester 160, and/or, more generally, the example side channel anomaly detector 102 of FIG. 1 is/are hereby expressly defined to include a non-transitory computer readable storage device or storage disk such as a memory, a digital versatile disk (DVD), a compact disk (CD), a Blu-ray disk, etc. including the software and/or firmware. Further still, the example side channel anomaly detector 102 of FIG. 1 may include one or more elements, processes and/or devices in addition to, or instead of, those illustrated in FIG. 1, and/or may include more than one of any or all of the illustrated elements, processes and devices. As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

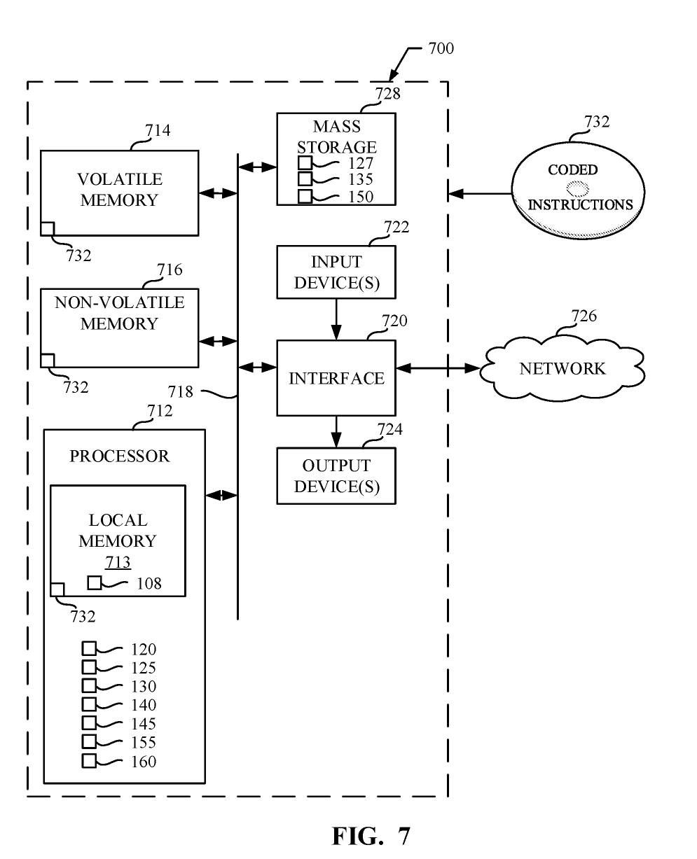

Flowcharts representative of example hardware logic, machine readable instructions, hardware implemented state machines, and/or any combination thereof for implementing the side channel anomaly detector 102 of FIG. 1 are shown in FIGS. 3, 4, and/or 5. The machine readable instructions may be an executable program or portion of an executable program for execution by a computer processor such as the processor 712 shown in the example processor platform 700 discussed below in connection with FIG. 7. The program may be embodied in software stored on a non-transitory computer readable storage medium such as a CD-ROM, a floppy disk, a hard drive, a DVD, a Blu-ray disk, or a memory associated with the processor 712, but the entire program and/or parts thereof could alternatively be executed by a device other than the processor 712 and/or embodied in firmware or dedicated hardware. Further, although the example program is described with reference to the flowcharts illustrated in FIGS. 3, 4, and/or 5, many other methods of implementing the example side channel anomaly detector 102 may alternatively be used. For example, the order of execution of the blocks may be changed, and/or some of the blocks described may be changed, eliminated, or combined. Additionally or alternatively, any or all of the blocks may be implemented by one or more hardware circuits (e.g., discrete and/or integrated analog and/or digital circuitry, an FPGA, an ASIC, a comparator, an operational-amplifier (op-amp), a logic circuit, etc.) structured to perform the corresponding operation without executing software or firmware.

As mentioned above, the example processes of FIGS. 3, 4, and/or 5 may be implemented using executable instructions (e.g., computer and/or machine readable instructions) stored on a non-transitory computer and/or machine readable medium such as a hard disk drive, a flash memory, a read-only memory, a compact disk, a digital versatile disk, a cache, a random-access memory and/or any other storage device or storage disk in which information is stored for any duration (e.g., for extended time periods, permanently, for brief instances, for temporarily buffering, and/or for caching of the information). As used herein, the term non-transitory computer readable medium is expressly defined to include any type of computer readable storage device and/or storage disk and to exclude propagating signals and to exclude transmission media.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc. may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, and (7) A with B and with C. As used herein in the context of describing structures, components, items, objects and/or things, the phrase “at least one of A and B” is intended to refer to implementations including any of (1) at least one A, (2) at least one B, and (3) at least one A and at least one B. Similarly, as used herein in the context of describing structures, components, items, objects and/or things, the phrase “at least one of A or B” is intended to refer to implementations including any of (1) at least one A, (2) at least one B, and (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, and (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, and (3) at least one A and at least one B.

FIG. 3 is a flowchart representative of machine readable instructions which may be executed to implement the example side channel anomaly detector 102 of FIG. 1. The example process 300 of FIG. 3 includes a training phase 301 and an operational phase 302. The example process 300 of FIG. 3 begins when the anomaly detection orchestrator 120 is initialized. Such initialization may occur, for example, upon startup of the example computing system 100 of FIG. 1, at the direction of a user, etc. The example anomaly detection orchestrator 120 enters the training phase 301, where the example anomaly detection orchestrator 120 trains a machine learning model and anomaly detection thresholds. (Block 310). An example process for training the machine learning model and the anomaly detection thresholds is described below in connection with the illustrated example of FIG. 4. A machine learning model is trained to identify cache access patterns as normal program execution (e.g., benign), to one or more attack phases (e.g., the priming phase, the observing phase, etc.). As such, the machine learning model is trained to determine whether an attack is in progress. In addition, multiple hypothesis testing is performed on histogram(s) of cache access(es) to determine an anomaly detection threshold.

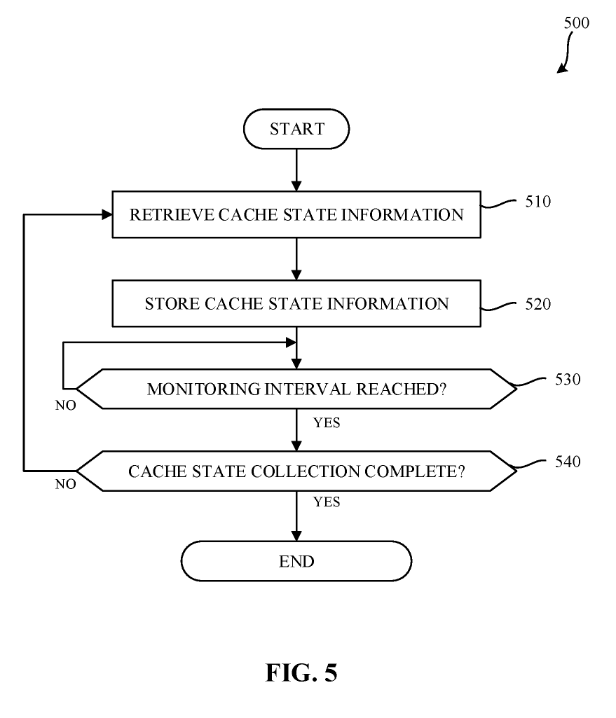

Once training is complete, the example side channel anomaly detector 102 enters the operational phase 302. The example cache state interface 125 samples the cache state from the cache 108. (Block 320). An example approach for sampling the cache state is described in further detail below in connection with FIG. 5. In examples disclosed herein, the cache state is sampled for both the level 1 Data (L1-D) and level 1 instruction (L1-I) caches. However, in some examples, other caches may additionally or alternatively be sampled such as, for example, the last-level cache (LLC). Alternatively, one of the L1-D cache or the L1-I cache may be sampled (e.g., instead of both of the caches). As noted above, Prime+Probe attacks target an L1 data cache (L1-D), an L1 instruction cache (L1-I), and Last-level caches (LLC), whereas Flush+Reload and Flush+Flush attacks mostly target LLC caches.

The example histogram generator 130 generates a histogram of the sampled cache state(s). (Block 330). In examples disclosed herein, a separate histogram is created for each sampled cache state. That is, a first histogram is created corresponding to the L1-D cache (e.g., an L1-D histogram), and a second histogram is created corresponding to the L1-I cache (e.g., an L1-I histogram). However, any number of histograms corresponding to any number of caches may additionally or alternatively be created.

The example histogram analyzer 140 extracts a histogram statistic(s) from the histogram(s). (Block 340). In examples disclosed herein, the statistic includes at least one of a minimum value, a maximum value, a percentile value, a standard deviation value, a skewness value, one or more values representing a range in the histogram, an upper-hinge value of the histogram, etc. In examples disclosed herein, separate statistics are created for each of the histogram(s). That is, a first statistic (and/or first set of statistics) is created for the L1-D histogram, and a second statistic (and/or second set of statistics) is created for the L1-I histogram.

The example machine learning model processor 145 operates on the statistic(s) with the machine learning model(s) stored in the 150 to determine one or more classifications. (Block 350). In examples disclosed herein, each machine learning model includes one or more one-class support vector machine(s) (SVMs). Each SVM is capable of producing a binary indication of whether the statistic(s) indicate a particular type of activity (e.g., no attack, a priming phase of an attack, a triggering phase of an attack, an observing phase of an attack, etc.). In examples disclosed herein, separate machine learning models are used for the each of the statistic(s) and/or set of statistics and, accordingly, are used in connection with each of the corresponding statistic(s). For example, a first machine learning model is used to classify the L1-D statistics and a second machine learning model is used to classify the L1-I statistics.

In connection with each machine learning model, binary values are returned for each respective particular type of activity (e.g., a classification). For example, a machine learning model may return a binary value (e.g., true or false) indicating whether a priming phase is identified, a binary value indicating whether a triggering phase is identified, a binary value indicating whether an observing phase is identified, and/or a binary value indicating whether benign activity is identified. However, any other type(s) of value(s) may additionally or alternatively be returned. For example, a numeric value representing a similarity score to a particular type of phase/activity may be returned. Moreover, in some examples, certain types of activities may be omitted from the returned data.

The example anomaly detection orchestrator 120 then determines whether the output classification(s) identify an attack. (Block 360). For example, an attack may be identified if at least one of the classifications indicate that the priming phase returns a result of true or that the observing phase returns a result of true. In some examples, an attack may be identified if the triggering phase returns a result of true, and/or if the benign activity classification returns a result of false. If no attack is identified (e.g., block 360 returns a result of NO), the example anomaly detection orchestrator 120 determines whether any further re-training is to occur. (Block 395). If training is not to occur (e.g., block 395 returns a result of NO), control returns to block 320, where regular monitoring continues. In some examples, additional checks to determine whether to terminate the process 300 of FIG. 3 may additionally be used. For example, the example process 300 of FIG. 3 may be terminated in response to a user request, the example process 300 may be terminated in response to a particular monitored application being terminated, etc. If re-training is to occur (e.g., block 395 returns a result of YES), control returns to block 310 where re-training occurs. In the illustrated example of FIG. 3, such retraining is illustrated as being performed in an offline fashion (e.g., training is performed while monitoring is not being performed). In some examples, such re-training may occur in parallel with ongoing monitoring (e.g., in a live fashion). That is, training may occur in an online fashion. In some examples, regularization is imposed to penalize false positives through, for example, a feedback loop. For example, as the anomaly detection orchestrator 120 produces anomaly predictions, subsequent training can be performed using information identifying whether the detected anomaly was truly an anomaly. For example, after a threshold number of false positives are detected, further training may be performed (e.g., control may return to block 310 for further training utilizing additional information concerning the false positives). In effect, such further training serves to reduce the number of false positives. In addition, false negatives may also be reduced.

Returning to block 360, if the example anomaly detection orchestrator 120 determines that at an attack has been identified (block 360 returns a result of YES), the example multiple hypothesis tester 160 conducts multiple hypothesis testing comparing the histogram(s) to one or more characteristic benign histograms stored in the histogram repository 135 to generate a p-value. (Block 370). In examples disclosed herein, the multiple hypothesis testing performed by the multiple hypothesis tester 160 is implemented using a Kolmogorov-Smirnov test. However, other types of multiple hypothesis testing algorithms may additionally or alternatively be used. The example p-value produced by the multiple hypothesis testing represents a similarity of the generated histogram(s) to the one or more characteristic benign histograms. In examples disclosed herein, p-values are created on a scale of zero to one. However, any other scale or nomenclature for representing a similarity may additionally or alternatively be used. A high p-value (e.g., a p-value near or approaching one, a p-value greater than or equal to 0.8) represents a high similarity to a benign histogram (i.e., that the generated histograms represent benign activity), whereas a low p-value (e.g., a p-value near approaching zero, a p-value less than or equal to 0.2) represents a low similarity to the benign histogram (i.e., that the generated histograms do not represent benign activity).

The example anomaly detection orchestrator 120 compares the p-value against the threshold (e.g., the threshold trained in connection with block 310, and described in further detail below in connection with FIG. 4). (Block 380). The example anomaly detection orchestrator 120 detects an anomaly if the p-value is less than or equal to the threshold (e.g., the histogram does not represent benign activity). However, any other approach to comparing the p-value to a threshold may additionally or alternatively be used. In this manner, a multi-stage anomaly detection approach includes utilizing a machine learning algorithm to classify whether a statistic of a histogram of cache states suggests that an attack is being performed and, in response to such an attack being detected, determining a probability that the histogram(s) represents benign activity. However, in some examples, such determination of the probability that the histogram(s) represents benign activity may instead be performed without respect to the results of the classification.

In response to the detection of the anomaly signifying potential onset or incidence of cache side channel attacks, (block 380 returning a result of YES), the example anomaly detection orchestrator 120 implements one or more responsive actions (e.g., error handling techniques) to mitigate such side channel attacks. (Block 390).

For example, the anomaly detection orchestrator 120 may inform the corresponding system software (OS/VMM) 110 of the detected anomaly through available inter-process communication and/or other communication approaches (e.g., flags, interrupts, etc.). In some examples, additional information such as, for example, attacker and/or victim domain identifiers (e.g., process identifiers and/or virtual machine identifiers of the process suspected to be under attack, process identifiers and/or virtual machine identifiers of the process suspected to be performing an attack) are utilized in classification and, as such, the OS/VMM 110 is notified of that information as well. In some examples, such information is obtained by a runtime and/or scheduler of the OS/VMM 110. Such information enables the two domains (e.g., the attack domain and the victim domain) to be physically separated (e.g., on two separate cores, on two separate CPUs) by the scheduler of the OS/VMM 110. Such separation minimizes the shared hardware resources between the two domains (process, VM, etc.) and thereby minimizes a risk that sensitive data may be exposed.

In some examples, the anomaly detection orchestrator 120 informs the OSS/VMM 110 about potential onset of the side channel attack. The OS/VMM 110 can enable one or more architectural feature(s) that defend against cache side channels. Such architectural features may be disabled by default to avoid performance costs, but may be enabled in situations where the potential onset of such an attack is detected. Such architectural features may include, for example, cache partitioning through cache allocation technology in LLC (of that CPU), activating memory tagging based capabilities for L1-I/D, limiting speculation of memory accesses across domains, activating flushing of at least the L1-I/D caches across context switches, etc.

In some examples, the performance of the responsive action involves further analysis to determine whether a side channel attack (or a particular phase thereof) is being performed. That is, the detection/identification disclosed above in connection with FIG. 3 may be used as a first level of screening. For example, more resource-intensive analysis of the histogram(s), statistics of the histogram(s), etc. may additionally be performed. In some examples, the potential attacker process is sandboxed (through methods guaranteed to be SC safe) by the OS/VMM 110 and more extensive monitoring is applied to the activities performed by the process such as, for example, trace-based profiling, dynamic binary-instrumentation based checks, etc.

In some examples, other error handling methods are used by the OS/VMM 110 to obtain such information such as, for example, dynamic enabling of settings and/or thresholds in a memory manager to prevent the use of shared memory (e.g., by the attacker process and the victim process) (critical in flush+reload, flush+flush) and flush all TLB states, disable or limit the privileges of CLFLUSH to Ring 0 only (will trap to OS such that it can monitor).

FIG. 4 is a flowchart representative of example machine readable instructions which may be executed to implement the example side channel anomaly detector of FIG. 1 to train a machine learning model and anomaly detection thresholds. The process 400 of the illustrated example of FIG. 4 begins when the example anomaly detection orchestrator 120 causes the OS/VMM 110 to execute the benign process 112. (Block 405). While the example benign process 112 is operating, the example cache state interface 125 samples the cache state from the cache 108. (Block 410). An example approach for sampling the cache state is described in further detail below in connection with FIG. 5. In examples disclosed herein, the cache state is sampled for both the level 1 Data (L1-D) and level 1 instruction (L1-I) caches. However, in some examples, other caches may additionally or alternatively be sampled such as, for example, the last-level cache (LLC). Alternatively, one of the L1-D cache or the L1-I cache may be sampled (e.g., instead of both of the caches). In examples disclosed herein, the cache state information is stored in the cache state memory 127 for later creation of a corresponding histogram. However, in some examples, the cache state information may be provided directly to the histogram generator 130 for generation of one or more histograms. The example anomaly detection orchestrator 120 then causes the OS/VMM 110 to terminate the benign process 112. (Block 415).

The example histogram generator 130 generates one or more histogram(s) of the sampled cache state(s). (Block 420). In examples disclosed herein, a separate histogram is created for each sampled cache state. That is, a first histogram is created corresponding to the L1-D cache (e.g., an L1-D histogram), and a second histogram is created corresponding to the L1-I cache (e.g., an L1-I histogram). However, any number of histograms corresponding to any number of caches may additionally or alternatively be created. The histogram(s) created in connection with block 420 represent benign operation (e.g., not an attack). The histogram(s) are stored in the histogram repository 135.

Next, the side channel anomaly detector 102 creates histogram(s) representing an attack. The example anomaly detection orchestrator 120 causes the OS/VMM 110 to execute the known (but non-malicious) attack process 114. (Block 425). In examples disclosed herein, the non-malicious attack process 114 is intended to simulate an actual side channel attack, but is not intended to actually expose sensitive information. In some examples, the attack process 114 is an actual attack process that would, under normal circumstances, expose sensitive information. However, in some examples, additional safeguards may be put in place to prevent the sharing of such sensitive information such as, for example, a firewall and/or other communication preventing approaches to prevent the attack process from sharing such sensitive information with a third party.

While the example attack process 114 is operating in a priming phase, the example cache state interface 125 samples the cache state from the cache 108. (Block 430). As noted above, an example approach for sampling the cache state is described in further detail below in connection with FIG. 5. In examples disclosed herein, the cache state is sampled for both the level 1 Data (L1-D) and level 1 instruction (L1-I) caches. However, in some examples, other caches may additionally or alternatively be sampled such as, for example, the last-level cache (LLC). Alternatively, one of the L1-D cache or the L1-I cache may be sampled (e.g., instead of both of the caches).

Upon completion of the priming phase of the attack process 114, the attack moves into a triggering phase. While the example attack process 114 is operating in the triggering phase, the example cache state interface 125 samples the cache state from the cache 108. (Block 435). Upon completion of the triggering phase of the attack process 114, the attack moves into an observing phase. While the example attack process 114 is operating in the observing phase, the example cache state interface 125 samples the cache state from the cache 108. (Block 440). In examples disclosed herein, the cache state information from each of the priming phase, triggering phase, and observing phase are stored separately from each other, as there are expected to be different cache access patterns in each of those phases. However, in some examples, cache state information for the separate phases may be combined. The example anomaly detection orchestrator 120 then causes the OS/VMM 110 to terminate the attack process 114. (Block 442).

Using the collected cache state information representing an attack, the example histogram generator 130 creates histogram(s) corresponding to each of the phases of the attack. (Block 445). In examples disclosed herein, separate histogram(s) are created for each sampled cache state. That is, a first histogram is created corresponding to the L1-D cache (e.g., an L1-D histogram) in the priming phase, a second histogram is created corresponding to the L1-I cache (e.g., an L1-I histogram) in the priming phase, a third histogram is created corresponding to the L1-D cache (e.g., an L1-D histogram) in the triggering phase, a fourth histogram is created corresponding to the L1-I cache (e.g., an L1-I histogram) in the triggering phase, a fifth histogram is created corresponding to the L1-D cache (e.g., an L1-D histogram) in the observing phase, and a sixth histogram is created corresponding to the L1-I cache (e.g., an L1-I histogram) in the observing phase. However, any number of histograms corresponding to any number of caches and/or attack phases may additionally or alternatively be created. The histogram(s) are stored in the histogram repository 135.

The example histogram analyzer 140 extracts histogram statistics from the histograms created in blocks 425 and block 445. (Block 450). That is, at least one statistic is determined in connection with each of the benign histogram(s), the priming phase attack histogram(s), the triggering phase attack histogram(s), and/or the observing phase attack histogram(s). In examples disclosed herein, the statistic(s) include at least one of a minimum value, a maximum value, a percentile value, a standard deviation value, a skewness value, one or more values representing a range in the histogram, an upper-hinge value of the histogram, etc. In examples disclosed herein, separate statistics are created for each of the histogram(s). That is, a first statistic (and/or first set of statistics) is created for the L1-D histogram, and a second statistic (and/or second set of statistics) is created for the L1-I histogram.

The example machine learning model trainer 155, in connection with the example machine learning model processor 145, trains one or more models based on the histogram statistics to produce an indication of whether an unknown process is exhibiting characteristics of an attack. (Block 455). In examples disclosed herein, the machine learning model is implemented by a one-class support vector machine (SVM). However, any other type of machine learning model may additionally or alternatively be used. During training, the example machine learning model trainer 155 updates the model(s) stored in the model data store 150 to reduce an amount of error generated by the example machine learning model processor 145 when using the histogram statistics to attempt to correctly output the desired response.

In examples disclosed herein, the model is trained to learn the cache access patterns of normal and/or benign program execution and of various attack phases (e.g., a priming phase, a triggering phase, an observing phase, etc.). In some examples, the triggering phase of an attack is considered normal and/or benign. In some examples, combinations of data from benign and/or attack operations are combined to allow for training to identify an attack occurring during benign operation. In some examples, the priming statistics and observing statistics are combined into a single malicious label and are considered for the detection as a binary classification problem.

As a result of the training, a model and/or an update to an existing model is created and is stored in the model data store 150. In examples disclosed herein, the model update can be computed with any sort of model learning algorithm such as, for example, Stochastic Gradient Descent.

The example multiple hypothesis tester 160 conducts multiple hypothesis testing comparing the attack histogram(s) to one or more characteristic benign histograms stored in the histogram repository 135 to generate a p-value threshold. (Block 460). In examples disclosed herein, the multiple hypothesis testing performed by the multiple hypothesis tester 160 is implemented using a Kolmogorov-Smirnov test. However, other types of multiple hypothesis testing algorithms may additionally or alternatively be used. The example p-value threshold produced by the multiple hypothesis testing represents a similarity threshold of the attack histograms and benign histograms that can be used to determine if histogram(s) of an unknown process are more similar to an attack operation or benign operation. In examples disclosed herein, p-value thresholds are created on a scale of zero to one. However, any other scale or nomenclature for representing a similarity and/or similarity threshold may additionally or alternatively be used. In examples disclosed herein, the resulting p-value threshold is set to reduce the number of false positives and/or false negatives. As such, additional histograms stored in the histogram repository 135 may be considered (e.g., histograms collected during operation of the side channel anomaly detector 102) to reduce a number of false positives. The example process 400 of FIG. 4 then terminates.

FIG. 5 is a flowchart representative of example machine readable instructions which may be executed to implement the example side channel anomaly detector of FIG. 1 to sample cache state information. In the illustrated example of FIG. 5, retrieval of cache state information is performed at periodic monitoring intervals for a threshold amount of time. The example process 500 of the illustrated example of FIG. 5 begins when the cache state interface 125 retrieves cache state information from the cache 108. (Block 510). The example cache state interface 125 stores the cache state information in the cache state memory 127. (Block 520). The example cache state interface 125 then waits until a monitoring interval has been reached. (Block 530). In examples disclosed herein, the monitoring interval represents time (e.g., 60 seconds, 5 minutes, etc.) However, any other approach to representing a monitoring interval (e.g., a number of executed instructions) may additionally or alternatively be used.

If the monitoring interval has not been reached (e.g., block 530 returns a result of NO), the example cache state interface 125 continues to wait until the monitoring interval has been reached. Upon reaching the monitoring interval (e.g., block 530 returns a result of YES), the example cache state interface 125 determines whether the collection of the cache state information is complete. (Block 540). In examples disclosed herein, cache state collection may be considered complete upon the expiration of the monitoring interval (which may, in some examples, represent a single sampling of cache state information). However, in some examples, collection may be considered to be complete when a threshold number of monitoring intervals have been reached (e.g., ten intervals, fifteen minutes, etc.)

If the collection of the cache state information is not complete (e.g., block 540 returns a result of NO), control returns to block 510, where the process of FIG. 5 is repeated until the collection is complete. Upon completion of the collection of the cache state information (e.g., block 540 returns a result of YES), the example process 500 of FIG. 5 terminates. The example process 500 of FIG. 5 may then be repeated at the direction of the anomaly detection orchestrator 120. In some examples, multiple instances of the example process 500 of FIG. 5 may be performed in parallel to, for example, simultaneously collect cache state information for the L1-D cache and the L1-I cache.

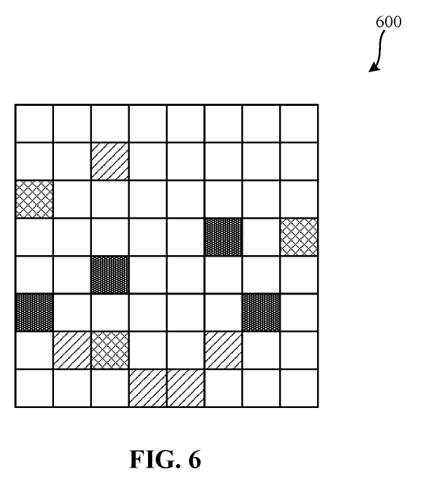

FIG. 6 is a diagram representing an example cache heat map (CHM) 600 that may be used in place of the example histogram of FIG. 2. In some examples, instead of utilizing a histogram to represent the cache, a Cache Heat Map (CHM) may be used to profile cache behavior. As used herein, the CHM is a data structure that represents how many times a particular cache set was accessed during a time interval. In other words, the CHM represents a composition of different activities in a certain cache set. As a result, cache access patterns may be learned from such a CHM to identify when a computing system is behaving in a normal manner, and/or when an attack is being executed. In the illustrated example of FIG. 6, the CHM 600 is represented as a two-dimensional image. Each pixel and/or cell of the two-dimensional image represents an amount of cache accesses for a given cache set at a particular time interval. When the CHM 600 of FIG. 6 is used instead of the histogram of FIG. 2, image recognition may be used by the histogram analyzer 140 to derive statistics of the CHM for use by the machine learning model processor 145.

FIG. 7 is a block diagram of an example processor platform 700 structured to execute the instructions of FIGS. 3, 4, and/or 5 to implement the side channel anomaly detector 102 of FIG. 1. The processor platform 700 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a DVD player, a CD player, a digital video recorder, a Blu-ray player, a gaming console, a personal video recorder, a set top box, a headset or other wearable device, or any other type of computing device.

The processor platform 700 of the illustrated example includes a processor 712. The processor 712 of the illustrated example is hardware. For example, the processor 712 can be implemented by one or more integrated circuits, logic circuits, microprocessors, GPUs, DSPs, or controllers from any desired family or manufacturer. The hardware processor may be a semiconductor based (e.g., silicon based) device. In this example, the processor implements the example anomaly detection orchestrator 120, the example cache state interface 125, the example histogram generator 130, the example histogram analyzer 140, the example machine learning model processor 145, the example machine learning model trainer 155, the example multiple hypothesis tester 160.

The processor 712 of the illustrated example includes a local memory 713 (e.g., a cache, such as the cache 108 of FIG. 1). The processor 712 of the illustrated example is in communication with a main memory including a volatile memory 714 and a non-volatile memory 716 via a bus 718. The volatile memory 714 may be implemented by Synchronous Dynamic Random Access Memory (SDRAM), Dynamic Random Access Memory (DRAM), RAMBUS® Dynamic Random Access Memory (RDRAM®) and/or any other type of random access memory device. The non-volatile memory 716 may be implemented by flash memory and/or any other desired type of memory device. Access to the main memory 714, 716 is controlled by a memory controller.

The processor platform 700 of the illustrated example also includes an interface circuit 720. The interface circuit 720 may be implemented by any type of interface standard, such as an Ethernet interface, a universal serial bus (USB), a Bluetooth® interface, a near field communication (NFC) interface, and/or a PCI express interface.

In the illustrated example, one or more input devices 722 are connected to the interface circuit 720. The input device(s) 722 permit(s) a user to enter data and/or commands into the processor 712. The input device(s) can be implemented by, for example, an audio sensor, a microphone, a camera (still or video), a keyboard, a button, a mouse, a touchscreen, a track-pad, a trackball, isopoint and/or a voice recognition system.

One or more output devices 724 are also connected to the interface circuit 720 of the illustrated example. The output devices 724 can be implemented, for example, by display devices (e.g., a light emitting diode (LED), an organic light emitting diode (OLED), a liquid crystal display (LCD), a cathode ray tube display (CRT), an in-place switching (IPS) display, a touchscreen, etc.), a tactile output device, a printer and/or speaker. The interface circuit 720 of the illustrated example, thus, typically includes a graphics driver card, a graphics driver chip and/or a graphics driver processor.

The interface circuit 720 of the illustrated example also includes a communication device such as a transmitter, a receiver, a transceiver, a modem, a residential gateway, a wireless access point, and/or a network interface to facilitate exchange of data with external machines (e.g., computing devices of any kind) via a network 726. The communication can be via, for example, an Ethernet connection, a digital subscriber line (DSL) connection, a telephone line connection, a coaxial cable system, a satellite system, a line-of-site wireless system, a cellular telephone system, etc.

The processor platform 700 of the illustrated example also includes one or more mass storage devices 728 for storing software and/or data. Examples of such mass storage devices 728 include floppy disk drives, hard drive disks, compact disk drives, Blu-ray disk drives, redundant array of independent disks (RAID) systems, and digital versatile disk (DVD) drives.

The machine executable instructions 732 of FIGS. 3, 4, and/or 5 may be stored in the mass storage device 728, in the volatile memory 714, in the non-volatile memory 716, and/or on a removable non-transitory computer readable storage medium such as a CD or DVD. In the illustrated example of FIG. 7, the example mass storage device 728 implements the example cache state memory 127, the example histogram repository 135, and/or the example model datastore 150.

From the foregoing, it will be appreciated that example methods, apparatus and articles of manufacture have been disclosed that enable detection of side channel attacks. Some such methods, apparatus and articles of manufacture disclosed herein improve the efficiency of using a computing device by enabling earlier detection of side channel attacks that, for example, detect an ongoing side channel attack before a data leak can occur. In this manner, data leaks can be prevented without the need for patching existing systems, applications, and/or hardware, thereby achieving one or more improvement(s) in the functioning of a computer.

Example 1 includes an apparatus for detecting side channel attacks, the apparatus comprising a histogram generator to generate a histogram representing cache access activities, a histogram analyzer to determine at least one statistic based on the histogram, a machine learning model processor to apply a machine learning model to the at least one statistic to identify an attempt to perform a side channel attack, a multiple hypothesis tester to perform multiple hypothesis testing to determine a probability of the cache access activities being benign, and an anomaly detection orchestrator to, in response to the machine learning model processor identifying that the at least one statistic is indicative of the side channel attack and the probability not satisfying a similarity threshold, cause the performance of a responsive action to mitigate the side channel attack.

Example 2 includes the apparatus of example 1, wherein the machine learning model is implemented by a support vector machine.

Example 3 includes the apparatus of example 1, wherein the multiple hypothesis tester is to perform the multiple hypothesis testing using a kolmogorov-smirnov test.

Example 4 includes the apparatus of example 1, further including a machine learning model trainer to train the machine learning model based on a benign histogram representative of benign cache access activities.

Example 5 includes the apparatus of example 1, further including a machine learning model trainer to train the machine learning model based on an attack histogram representative of cache access activities performed during the side channel attack.

Example 6 includes the apparatus of example 1, further including a cache state interface to sample a cache state of a processor, the histogram generator to generate the histogram based on the sampled cache state.

Example 7 includes at least one non-transitory computer-readable medium comprising instructions that, when executed, cause at least one processor to at least create a histogram representing cache access activities, determine at least one statistic based on the histogram, apply a machine learning model to the at least one statistic to attempt to identify a side channel attack, perform multiple hypothesis testing on the histogram to determine a probability of the cache access activities being benign, and in response to determining that the at least one statistic is indicative of the side channel attack and the probability not satisfying a similarity threshold, perform a responsive action to mitigate the side channel attack.

Example 8 includes the at least one non-transitory computer-readable medium of example 7, wherein the machine learning model is implemented using a support vector machine.

Example 9 includes the at least one non-transitory computer-readable medium of example 7, wherein the instructions, when executed, cause the at least one processor to perform the multiple hypothesis testing with a kolmogorov-smirnov test.

Example 10 includes the at least one non-transitory computer-readable medium of example 7, wherein the instructions, when executed, cause the at least one processor to train the machine learning model based on a benign histogram representative of benign cache access activities.

Example 11 includes the at least one non-transitory computer-readable medium of example 7, wherein the instructions, when executed, cause the at least one processor to train the machine learning model based on an attack histogram representative of cache access activities performed during the side channel attack.

Example 12 includes the at least one non-transitory computer-readable medium of example 7, wherein the instructions, when executed, cause the at least one processor to sample a cache state of the at least one processor, wherein the histogram is generated based on the sampled cache state.

Example 13 includes an apparatus for detecting side channel attacks, the apparatus comprising means for generating a histogram representing cache access activities, means for determining at least one statistic from the histogram, means for applying a machine learning model to classify the at least one statistic as indicative of a side channel attack, means for testing using the histogram based on multiple hypothesis testing to determine a probability of the cache access activities being benign, and means for mitigating the side channel attack in response to determining that the at least one statistic is indicative of the side channel attack and the probability not satisfying a similarity threshold.

Example 14 includes the apparatus of example 13, wherein the machine learning model includes a support vector machine.

Example 15 includes the apparatus of example 13, wherein the testing means is to perform the multiple hypothesis testing using a kolmogorov-smirnov test.

Example 16 includes the apparatus of example 13, further including means for training the machine learning model based on a benign histogram representative of benign cache access activities.

Example 17 includes the apparatus of example 13, further including means for training the machine learning model based on an attack histogram representative of cache access activities performed during the side channel attack.

Example 18 includes the apparatus of example 13, further including means for sampling a cache state, the means for generating to generate the histogram based on the sampled cache state.

Example 19 includes a method for detecting side channel attacks, the method comprising creating, by executing an instruction with a processor, a histogram representing cache access activities, determining at least one statistic based on the histogram, applying a machine learning model to the at least one statistic to attempt to identify a side channel attack, performing multiple hypothesis testing on the histogram to determine a probability of the cache access activities being benign, and in response to identifying the side channel attack and the probability not satisfying a similarity threshold, performing a responsive action to mitigate the side channel attack.

Example 20 includes the method of example 19, wherein the machine learning model is implemented using a support vector machine architecture.

Example 21 includes the method of example 19, wherein the performing of the multiple hypothesis testing includes performing a kolmogorov-smirnov test.

Example 22 includes the method of example 19, further including training the machine learning model based on a benign histogram representative of benign cache access activities.

Example 23 includes the method of example 19, further including training the machine learning model based on an attack histogram representative of cache access activities performed during the side channel attack.

Example 24 includes the method of example 19, further including sampling a cache state of the processor, wherein the histogram is generated based on the sampled cache state.

Although certain example methods, apparatus and articles of manufacture have been disclosed herein, the scope of coverage of this patent is not limited thereto. On the contrary, this patent covers all methods, apparatus and articles of manufacture fairly falling within the scope of the claims of this patent.

What is claimed is:

1. An apparatus for detecting side channel attacks, the apparatus comprising:
a histogram generator to generate a histogram representing cache access activities;
a histogram analyzer to determine at least one statistic based on the histogram;
a machine learning model processor to apply a machine learning model to the at least one statistic to identify an attempt to perform a side channel attack;
a multiple hypothesis tester to perform multiple hypothesis testing to determine a probability of the cache access activities being benign; and
an anomaly detection orchestrator to, in response to the machine learning model processor identifying that the at least one statistic is indicative of the side channel attack and the probability not satisfying a similarity threshold, cause the performance of a responsive action to mitigate the side channel attack.

2. The apparatus of claim 1, wherein the machine learning model is implemented by a support vector machine.

3. The apparatus of claim 1, wherein the multiple hypothesis tester is to perform the multiple hypothesis testing using a Kolmogorov-Smirnov test.

4. The apparatus of claim 1, further including a machine learning model trainer to train the machine learning model based on a benign histogram representative of benign cache access activities.

5. The apparatus of claim 1, further including a machine learning model trainer to train the machine learning model based on an attack histogram representative of cache access activities performed during the side channel attack.

6. The apparatus of claim 1, further including a cache state interface to sample a cache state of a processor, the histogram generator to generate the histogram based on the sampled cache state.

7. At least one non-transitory computer-readable medium comprising instructions that, when executed, cause at least one processor to at least:
create a histogram representing cache access activities;
determine at least one statistic based on the histogram;
apply a machine learning model to the at least one statistic to attempt to identify a side channel attack;
perform multiple hypothesis testing on the histogram to determine a probability of the cache access activities being benign; and
in response to determining that the at least one statistic is indicative of the side channel attack and the probability not satisfying a similarity threshold, perform a responsive action to mitigate the side channel attack.

8. The at least one non-transitory computer-readable medium of claim 7, wherein the machine learning model is implemented using a support vector machine.

9. The at least one non-transitory computer-readable medium of claim 7, wherein the instructions, when executed, cause the at least one processor to perform the multiple hypothesis testing with a Kolmogorov-Smirnov test.

10. The at least one non-transitory computer-readable medium of claim 7, wherein the instructions, when executed, cause the at least one processor to train the machine learning model based on a benign histogram representative of benign cache access activities.

11. The at least one non-transitory computer-readable medium of claim 7, wherein the instructions, when executed, cause the at least one processor to train the machine learning model based on an attack histogram representative of cache access activities performed during the side channel attack.

12. The at least one non-transitory computer-readable medium of claim 7, wherein the instructions, when executed, cause the at least one processor to sample a cache state of the at least one processor, wherein the histogram is generated based on the sampled cache state.

13. An apparatus for detecting side channel attacks, the apparatus comprising:
means for generating a histogram representing cache access activities;
means for determining at least one statistic from the histogram;
means for applying a machine learning model to classify the at least one statistic as indicative of a side channel attack;
means for testing using the histogram based on multiple hypothesis testing to determine a probability of the cache access activities being benign; and
means for mitigating the side channel attack in response to determining that the at least one statistic is indicative of the side channel attack and the probability not satisfying a similarity threshold.

14. The apparatus of claim 13, wherein the machine learning model includes a support vector machine.

15. The apparatus of claim 13, wherein the testing means is to perform the multiple hypothesis testing using a Kolmogorov-Smirnov test.

16. The apparatus of claim 13, further including means for training the machine learning model based on a benign histogram representative of benign cache access activities.

17. The apparatus of claim 13, further including means for training the machine learning model based on an attack histogram representative of cache access activities performed during the side channel attack.

18. The apparatus of claim 13, further including means for sampling a cache state, the means for generating to generate the histogram based on the sampled cache state.

19. A method for detecting side channel attacks, the method comprising:
creating, by executing an instruction with a processor, a histogram representing cache access activities;
determining at least one statistic based on the histogram;
applying a machine learning model to the at least one statistic to attempt to identify a side channel attack;
performing multiple hypothesis testing on the histogram to determine a probability of the cache access activities being benign; and
in response to identifying the side channel attack and the probability not satisfying a similarity threshold, performing a responsive action to mitigate the side channel attack.

20. The method of claim 19, wherein the machine learning model is implemented using a support vector machine architecture.

21. The method of claim 19, wherein the performing of the multiple hypothesis testing includes performing a Kolmogorov-Smirnov test.

22. The method of claim 19, further including training the machine learning model based on a benign histogram representative of benign cache access activities.

23. The method of claim 19, further including training the machine learning model based on an attack histogram representative of cache access activities performed during the side channel attack.

24. The method of claim 19, further including sampling a cache state of the processor, wherein the histogram is generated based on the sampled cache state.
